(19) United States
(12) Patent Application Publication
(10) Pub. No.: US 2009/0207768 A1
(43) Pub. Date: Aug. 20, 2009

(54) OPTIMAL CROSS-LAYER SCHEDULING FOR MULTI-USER COMMUNICATION SYSTEMS WITH IMPERFECT CHANNEL STATE INFORMATION AND UNKNOWN INTERFERENCE

(75) Inventors: Rui Wang, Hong Kong (CN); Vincent Kin Nang Lau, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/033,664

(22) Filed: Feb. 19, 2008

(51) Int. Cl. G08C 17/00; H04L 27/28; H04J 3/00

(52) U.S. Cl. 370/311; 375/260; 370/280

(57) ABSTRACT

The disclosed subject matter provides scheduling algorithms, methods, and systems that facilitate cross layer scheduling for systems with imperfect channel state information and unknown interference. By exploiting ACK/NAK feedback from users of downlink traffic and recursively optimizing scheduling policy components over a state space, the disclosed subject matter provide robust and optimal cross layer scheduling in the presence of unknown interference and imperfect channel state information. The disclosed details enable various refinements and modifications according to cross layer schedule and system design considerations.

### TECHNICAL FIELD

The subject disclosure relates to cross layer scheduling in multi-user communication systems, and more specifically to cross-layer scheduling for systems with imperfect channel state information and unknown interference.

### BACKGROUND

Recently, cross-layer scheduling in Orthogonal Frequency Division Multiple Access (OFDMA) systems has received tremendous attention. For example, high spectral efficiency can be achieved by exploiting multi-user selection diversity over the temporal and frequency domains. Generally, a multiple-access communication system (e.g., a wireless communication system) can support simultaneous communication for multiple terminals (e.g., mobile units). Each terminal communicates with one or more base stations via transmissions on the forward and reverse links. The forward link (or downlink (DL)) refers to the communication link from the base stations to the terminals, and the reverse link (or uplink (UL)) refers to the communication link from the terminals to the base stations.

To exploit the multi-user selection diversity, knowledge of Channel State Information at the Transmitter (CSIT) or base station is frequently used. However, obtaining perfect CSIT at the base station is very challenging even for Time Division Duplexed (TDD) systems, especially for large number of subcarriers M or large number of users K. For instance, in TDD systems, even if the downlink CSIT can be estimated from the dedicated uplink pilots due to channel reciprocity, the base station and the mobile stations may still experience different and bursty interference which is not reciprocal.

As a result, an uplink and a downlink of a TDD system may not be reciprocal for many reasons. As an example, Radio Frequency (RF) chains in the downlink and uplink may introduce different phase shifts, which can be corrected by performing a calibration. As a further example, the base station and mobile stations may see different interference that cannot be corrected using calibration due to the bursty nature of the interference.

When the base station has perfect knowledge of CSIT, the transmitted packet can be virtually error free (e.g., with powerful error correction coding) in slow fading channels and hence, the system can achieve ergodic capacity. However, when there is imperfect CSIT (and/or as well as unknown interference) at the base station, the scheduled data rate may be larger than instantaneous channel capacity (e.g., instantaneous channel capacity unknown to the transmitter). As a result, this can lead to packet transmission error even the event a powerful error correction code is applied. Moreover, the efficiency of the multi-user scheduling is reduced because it is possible that a wrong set of users is selected for transmission.

Most of the existing cross-layer solutions have addressed the issue of imperfect CSIT based on heuristic approaches. For example, one cross-layer scheduler assumes CSIT is perfect and the effect of imperfect CSIT is evaluated by simulations. However, this approach does not offer any design insight on what should be the optimal design and performance with imperfect CSIT because the optimal design can be quite different from that with perfect CSIT. In addition, it can be seen that the performance of the naive cross-layer scheduler (e.g., that designed for perfect CSIT) is very sensitive to imperfect CSIT even with very small errors in CSIT.

Although some solutions have attempted to take into account imperfect CSIT, these solutions require knowledge of the CSIT error and interference statistics (e.g., error distribution or error variance), which is typically impracticable to obtain.

In addition, many solutions approach cross-layer designs from an open loop perspective. For example, in open-loop scheduling, a set of admitted users, power allocation, and rate allocation are determined based on the estimated CSIT in addition to estimated interference. Moreover, these solutions typically use the estimated CSIT for an entire scheduling time slot (e.g., it is assumed to be constant in this interval).

Other proposed solutions approach cross-layer designs using closed loop adaptations with the Acknowledgement/Negative Acknowledgement (ACK/NAK) feedback. While one such solution presents a power and rate control policy for a point-to-point system with delay constrained traffic based on ACK/NAK feedback, the cross layer scheduling (e.g., user selection) issue is not addressed. Another proposed solution presents a heuristic adaptive rate control and randomized scheduling algorithm for flat-fading channels based on learning automata.

However, in all such solutions, the solutions are heuristic that provide no insight into how well the heuristic solutions approach optimal performance. In addition, knowledge of CSIT errors was required and/or the solutions did not address the potential issue of unknown interference, which is typically impracticable to obtain. As a result, further improvements in cross-layer scheduling are desired to provide, optimal, robust, and practical designs.

The above-described deficiencies are merely intended to provide an overview of some of the problems encountered in developing optimal and robust cross-layer scheduler designs, and are not intended to be exhaustive. Other problems with the state of the art may become further apparent upon review of the description of the various non-limiting embodiments of the disclosed subject matter that follows.

### SUMMARY

In consideration of the above-described deficiencies of the state of the art, the disclosed subject matter provides cross layer scheduling algorithms, methods, and systems that facilitate cross-layer scheduling for systems with imperfect channel state information and unknown interference.

Advantageously, the disclosed subject matter, in one aspect thereof, can facilitate exploiting the ACK/NAK (1-bit) feedback signals from system mobile units. As a result, designs according to various aspects of the disclosed subject matter do not require knowledge of the CSIT error nor interference statistics.

As a result, according to various non-limiting embodiments, the disclosed subject matter can provide robust and optimal closed-loop cross-layer algorithms and methods suitable for downlink Time Division Duplexed Orthogonal Frequency Division Multiple Access (TDD-OFDMA) systems with imperfect CSIT and unknown interference in slow fading channels.

To that end, the disclosed subject matter, in various aspects thereof, can facilitate using an average system goodput (e.g., measuring the average b/s/Hz successfully delivered to the mobile) as an optimization objective, to account for potential packet errors due to the imperfect CSIT and/or unknown interference. On that basis, various aspects of the disclosed subject matter can facilitate cross-layer scheduling formulated as a state-space control problem. As a result, optimal power, rate, and user allocation can be determined as the output equations from the system state based on a dynamic programming approach. The disclosed subject matter, in various non-limiting embodiments can be shown to provide proposed closed-loop cross-layer design is very robust with respect to imperfect CSIT, unknown interference, model mismatch as well as channel variations due to Doppler shift.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the disclosed subject matter in a simplified form as a prelude to the more detailed description that follows.

### BRIEF DESCRIPTION OF THE DRAWINGS

The cross layer scheduling algorithms, methods, and systems are further described with reference to the accompanying drawings in which:

FIG. 1 illustrates an overview of a wireless communication environment suitable for incorporation of embodiments of the disclosed subject matter;

FIG. 2 illustrates an exemplary non-limiting block diagram of a system suitable for practicing embodiments of the disclosed subject matter;

FIG. 3 depicts an exemplary non-limiting scheduling slot structure suitable for practicing embodiments of the disclosed subject matter;

FIG. 4 illustrates an exemplary structure of a non-limiting embodiment of a closed-loop cross-layer scheduler according to various aspects of the disclosed subject matter;

FIG. 5 illustrates an exemplary non-limiting high level methodology for cross-layer scheduler according to various aspects of the disclosed subject matter;

FIG. 6 illustrates a block diagram of an exemplary non-limiting device that facilitates cross-layer scheduling according to various aspects of the disclosed subject matter;

FIG. 7 depicts average goodput performance versus transmit power according to various embodiments of the disclosed subject matter;

FIG. 8 depicts average goodput performance of packet bursts according to various embodiments of the disclosed subject matter;

FIG. 9 depicts the average goodput performance versus Doppler frequency according to various embodiments of the disclosed subject matter;

FIG. 10 depicts the transient of the instantaneous scheduled data rate and the actual instantaneous channel capacity versus time according to particular embodiments of the disclosed subject matter;

FIG. 11 depicts the transient of the instantaneous scheduled data rate and the actual instantaneous channel capacity versus time according to further embodiments of the disclosed subject matter;

FIG. 12 illustrates a block diagram representing an exemplary non-limiting networked environment in which the disclosed subject matter may be implemented;

FIG. 13 illustrates a block diagram representing an exemplary non-limiting computing system or operating environment in which the disclosed subject matter may be implemented; and

FIG. 14 illustrates an overview of a network environment suitable for service by embodiments of the disclosed subject matter.

### DETAILED DESCRIPTION

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the disclosed subject matter in a simplified form as a prelude to the more detailed description of these and various other embodiments of the disclosed subject matter that follow. It is understood that various modifications may be made by one skilled in the relevant art without departing from the scope of the disclosed subject matter. Accordingly, it is the intent to include within the scope of the disclosed subject matter those modifications, substitutions, and variations as may come to those skilled in the art based on the teachings herein.

In consideration of the above-described deficiencies of the state of the art, the disclosed subject matter provides cross layer scheduling algorithms, methods, and systems that facilitate cross-layer scheduling for systems with imperfect channel state information and unknown interference. Cross-layer designs for OFDMA systems have been shown to offer significant gains of spectral efficiency by exploiting multi user selection diversity over the temporal and frequency domains. However, conventional solutions either assume perfect knowledge of channel state information at the transmitter (CSIT), or do not address the impracticalities of obtaining CSIT error information.

For example, for TDD systems, even if channel reciprocity holds after calibration, the base station and the mobile stations may see different bursty interference which is not reciprocal. Thus, when there is imperfect CSIT and/or unknown interference at the receiver, there can be packet transmission errors and/or outages. According to various non-limiting embodiments, the disclosed subject matter can facilitate robust cross-layer designs for downlink OFDMA systems with imperfect CSIT and unknown interference for slow frequency selective fading channels. According to further non-limiting embodiments, the disclosed subject matter can provide robust optimal cross-layer designs for downlink TDD-OFDMA systems with imperfect channel state information (CSIT) and unknown interference in slow fading channels.

Advantageously, the disclosed subject matter, in one aspect thereof, can facilitate exploiting the ACK/NAK feedback signals (e.g., 1-bit feedback signals) from system mobile units. For example, ACK/NAK feedback from mobile units are typically available from conventional MAC layers regardless of whether cross-layer scheduling is employed. As a result, the disclosed subject matter, in various aspects thereof, does not induce extra system overhead. In addition, designs according to various aspects of the disclosed subject matter do not require knowledge of the CSIT error nor interference statistics. As a result, according to various non-limiting embodiments, the disclosed subject matter can provide robust and optimal closed-loop cross-layer algorithms and methods suitable for downlink Time Division Duplexed Orthogonal Frequency Division Multiple Access (TDD-OFDMA) systems with imperfect CSIT and unknown interference in slow fading channels.

To that end, the disclosed subject matter, in various aspects thereof, can facilitate using an average system goodput (e.g., measuring the average b/s/Hz successfully delivered to a mobile unit) as an optimization objective to account for potential packet errors due to the imperfect CSIT and/or unknown interference. On that basis, various aspects of the disclosed subject matter can facilitate cross-layer scheduling formulated as a state-space control problem. As a result, optimal power, rate, and user allocation can be determined as the output equations from the system state based on a dynamic programming approach using backward and forward recursion algorithms.

The disclosed subject matter, in various non-limiting embodiments can be shown to provide robust goodput performance with respect to imperfect CSIT (e.g., moderate to high CSIT errors), unknown interference (e.g., moderate to high interference power), and model mismatch, as well as moderate channel variations due to Doppler shift.

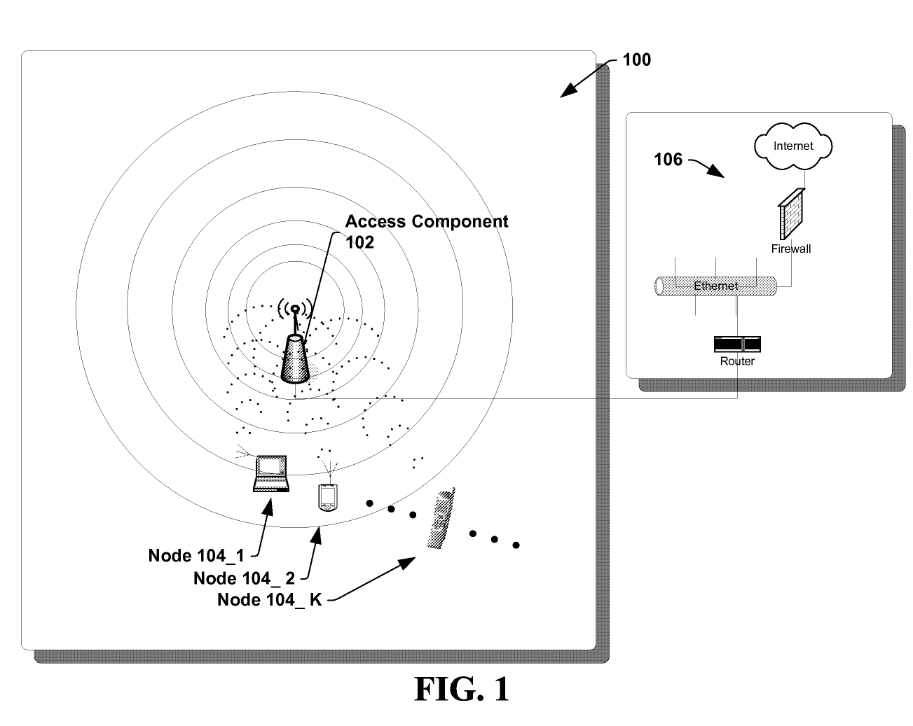

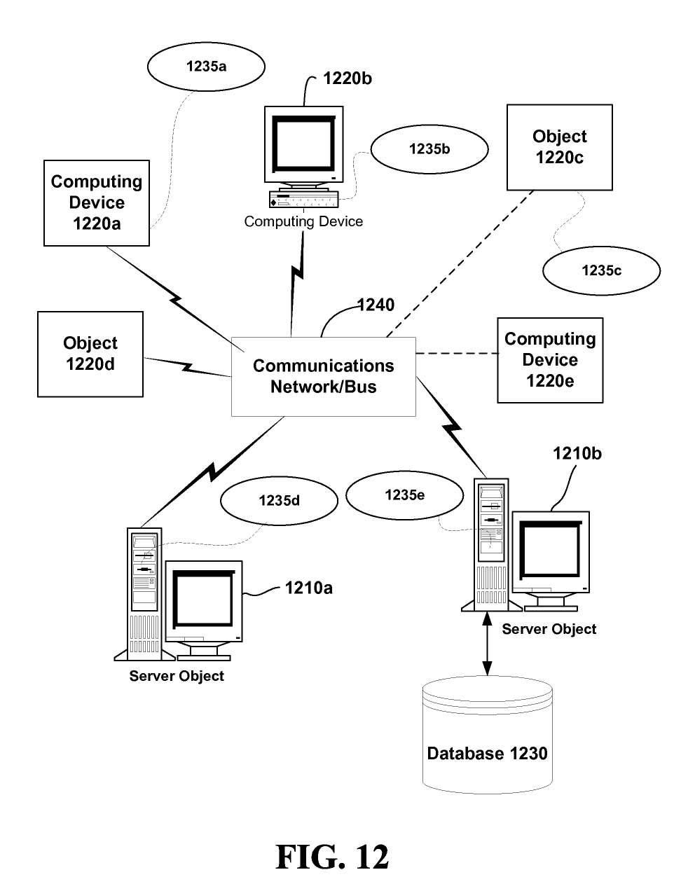

FIG. 1 is an exemplary, non-limiting block diagram generally illustrating a wireless communication environment 100 suitable for incorporation of embodiments of the disclosed subject matter. Wireless communication environment 100 contains a number of nodes 104 operable to communicate with a base station component 102 over a wireless communication medium and according to an agreed protocol. As described in further detail below, such nodes and base station components typically contain a receiver and transmitter configured to receive and transmit communications signals from and to other nodes or base station components. FIG. 1. illustrates that there can be any arbitrary integral number of nodes, and it can be appreciated that due to variations in transmission path, node characteristics, scattering environment, and other variables, the subject disclosed subject matter is well-suited for use in such a diverse environment. Optionally, the base station component 102 may be accompanied by one or more additional base station components and may be connected to other suitable networks and or wireless communication systems as described below with respect to FIGS. 12-14.

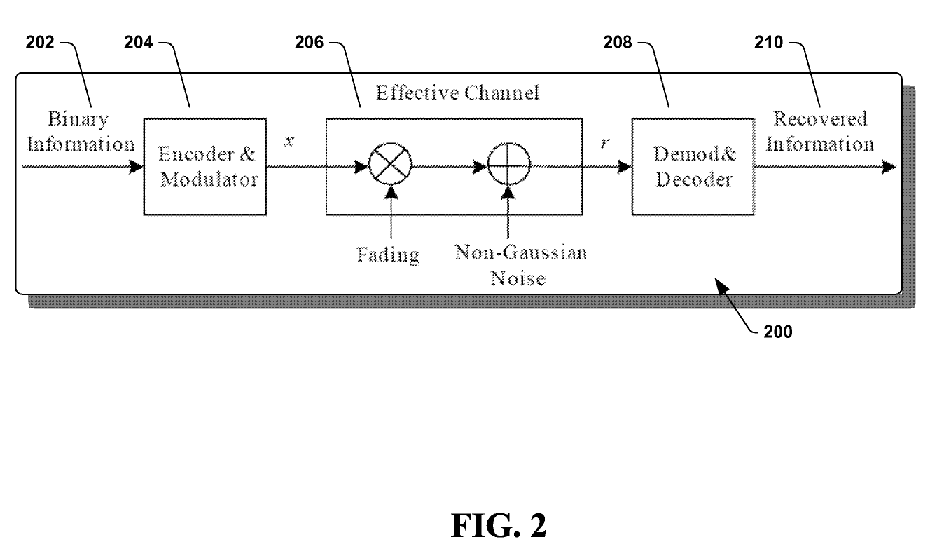

FIG. 2 illustrates an exemplary non-limiting block diagram of a system 200 suitable for practicing embodiments of the disclosed subject matter. Binary information sequences 202 are encoded and modulated at the transmitter side 204. The data sequence is passed through the channel 206 and is demodulated and decoded 208 at the receiver side. It is noted that the effective channel includes all possible processing and noise sources occurring between the modulator and the demodulator.

In most of the works on communications, the transmitted data is assumed to be corrupted by Gaussian noise. The Gaussian model is successful in modeling some important random phenomena such as thermal noise and leads to tractable equations. However, in many realistic communication environments, the transmission is additionally disturbed by high amplitude interference so that the overall noise statistics deviate from the Gaussian distribution (including for example, naturally occurring and man-made impulsive noise in wireless communication environments, impulsive noise in wired communication channels, and non-Gaussian interference due to the sharing of communication medium).

For example, impulsive noise has been observed in both outdoor and indoor radio communication environments through extensive measurements. The source of the impulsive noise may be naturally occurring or man-made. Naturally occurring radio frequency sources include atmospheric, solar, and cosmic noise sources. Below 20 MHz, atmospheric noise predominates over other natural sources. From 1 MHz to 10 GHz, the radio noise sources include solar-flare radio-noise radiation, lunar emission and galactic noise. Impulsive noise from automobiles is generated mainly by the ignition system. Impulses arise from the discharge of the coaxial capacitor of the spark plug. The radiated noise exists in the frequency band from 30 MHz up to 7 GHz. In urban areas, the automotive ignition noise is a significant impulsive noise sources. Noise radiated from electric-power generation, transformation, and transport facilities is another important impulsive radio noise source which occurs within the spectral range extending from the fundamental generation frequency (usually 50 Hz) into the ultra high frequency band. Gap-discharge and corona-discharge are the major sources of radio interference in the electric-power facilities.

The noise in power-distribution lines may be comparable or greater than the automobile ignition noise in rural areas. Impulsive noise measurements for indoor environments have been conducted for the frequency bands from 900 MHz up to 4 GHz, which are currently used or are considered for future indoor wireless systems. The principle sources of radio impulsive noise sources in indoor environments are the devices with electromechanical switches including electric motors in elevators, refrigeration units, copy machines, printers, etc. The peak amplitude of the impulsive noise can be as large as 40 dB higher relative to the measured thermal noise. The average pulse duration is in the order of a few hundred nanoseconds.

In digital subscriber line (DSL) loops, the impulsive noise is one of the most damaging impairments. In unshielded twisted pairs, impulsive noise can be generated by signaling circuits, transmission and switching gear, electrostatic discharges, lightning surges and so forth. It has been reported that the typical impulsive noise occurs about 1 to 5 times per minute and has a time duration ranging from 30 μs to 150 μs and can exceed 500 μs.

Power lines form a potentially convenient and inexpensive communication medium for their omnipresence even in rural or remote areas where telephone, cable and wireless networks are difficult to cover. Impulsive noise exists in power line communication (PLC) channels and can be categorized into two classes: synchronous and asynchronous impulsive noise. Asynchronous impulsive noise is mainly caused by switching transients that occur all over a power supply network at irregular intervals. Like in DSL loops, the duration of the impulsive noise frequently exceeds the symbol interval. The impulse width is in the order of 100 μs and the interval time is around 100 μs. Normally, the disturbance ratio is less than 1%.

The explosive growth of wireless services in recent years illustrates the huge and growing demand for spectrum-based communications. Due to the limited frequency resources, the frequency is reused by various users and various communication applications. The users that share the same propagation medium become interference sources for other simultaneous users. Assuming the interfering users are spatially Poisson distributed and under a power-law propagation loss function, it has been shown that the co-channel interference can be modeled as an α-stable distribution. For example, IEEE 802.11g Wireless Local Area Network (WLAN) systems operates in the same frequency band as Bluetooth systems, which are narrowband frequency-hopping systems. For a typical 200 μs long WLAN packet, the probability of collision with a Bluetooth packet is more than 20%.

Multiple access interference in a Code-Division-Multiple-Access (CDMA) system is a wide-band, non-stationary stochastic process. The randomness of the interference comes mainly from three stochastic sources (e.g., radio propagation, traffic variation, and mobile distribution). It has been shown that such interference is bursty in nature. The variation in the interference power is relatively large for a small number of users and for a shorter inter-arrival time for packet data calls. The integration of data communication services also increases the variation relative to voice-only communication systems.

Moreover, it has been shown that with power control, overall multiple-access interference has “peakings” which come mostly from distant users. This can occur due to perfect tracking of deep fades by only a few users, or even a single dominant user, thus driving the overall interference statistics away from the central limit theorem. These interference distributions are not well studied. It is therefore not straightforward to find a suitable mathematical model for the noise in such wireless communication systems.

Similarly, in frequency-hopped (FH) systems, a number of symbols are transmitted during the same dwell interval through a hopped frequency band. Once the transmitted symbols are hopped into the fraction of band where the partial band jammer for other users are present, the symbols become corrupted. Due to the time-varying nature of the impulsive noise, it is difficult to estimate its distribution accurately. In addition, the difficulty in selecting an appropriate noise model presents an additional problem.

### OFDMA System Model

For the purposes of illustration and not limitation, various embodiments of the disclosed subject matter are described in an information theoretical approach. As a result, the performance of a physical layer can be decoupled from specific channel coding and modulation schemes. In addition, for the purpose of describing system performance decoupled from data source statistics, various embodiments are described assuming data sources that are delay insensitive (e.g., large buffers size so as to always contain source packets waiting to be transmitted). In other words, the following description assumes that there are no empty scheduling slots due to insufficient source packets at the buffers.

In the sections that follow, a slow fading channel model is described, followed by a description of a CSIT error and unknown interference model, a multi-user physical layer model, and well as the MAC layer model. It should be appreciated that such descriptions are provided for the purposes of illustration and not limitation. Thus, it should be further appreciated that various modifications can be made without departing from the scope of the claims appended hereto. In addition, the following symbols an terminology are used in the sections that follow: where h is the actual CSI; h^{b} is the estimated CSIT; U(P₀, A, R, P) is the average total goodput, which can measure the average total b/s/Hz (e.g., spectral efficiency) successfully delivered to mobile units; G(P₀, h^{b}, R, P) is the conditional system goodput conditioned on the estimated CSIT h^{b}; g̅ₙ(h^{b}, Sₙ) is the conditional average goodput of the n-th packet burst conditioned on the CSIT h^{b} and current system state Sₙ; and Fₙ(P, h^{b}, Sₙ) is the conditional average goodput from the n-th packet burst to the last packet burst conditioned on the CSIT h^{b} and current system state Sₙ.

One slow fading channel model can be considered as a communication system with K mobile users and one base station over a slow-varying frequency selective fading channel with M as the number of subcarriers in the system.

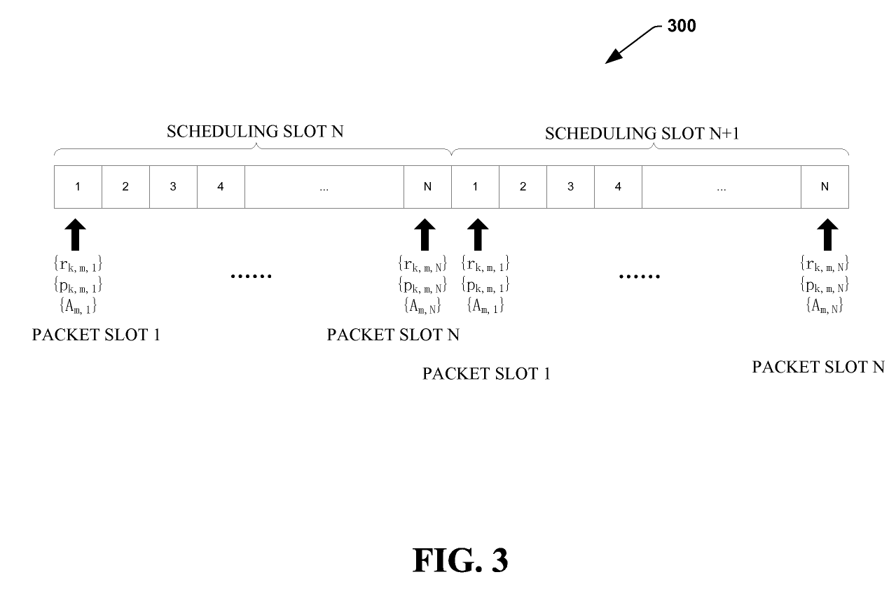

FIG. 3 depicts an exemplary non-limiting scheduling slot structure 300 comprising N packet bursts suitable for practicing embodiments of the disclosed subject matter. The disclosed subject matter, in one aspect thereof, is suitable for use by mobile users (e.g., mobile pedestrian users with mobility less than about 5 kilometers per hour (km/hr)), which for example, can result in a coherence time (90% correlation) around 4 milliseconds (ms) at f_{c}=2.4 GHz. In that context, the channel fading remains quasi-static within a duration of 4 ms. Accordingly, it can be presumed that a channel is quasi-statistic within a scheduling slot as described herein.

For X_{m,n} as a transmit symbol in an m-th subcarrier and n-th packet burst, a received signal Y_{k,m,n} of the k-th user in the m-th subcarrier and the n-th packet burst can be expressed as:

Y_{k,m,n}=h_{k,m}X_{m,n}+Z_{k,m,n}+I_{k,m,n} Eqn. 1

where h_{k,m} can be defined as a channel coefficient of the m-th subcarrier and the k-th user, which can be Independent, Identically Distributed (i.i.d.) complex Gaussian distributed with zero mean and unit variance; Z_{k,m,n} can be defined as i.i.d. zero-mean complex Gaussian noise with variance σ_{z}²/M; and I_{k,m,n} can denote zero-mean complex Gaussian interference (e.g., due to other cell interference) at the k-th mobile receiver with variance βₖ²/M.

A model for CSIT error and unknown interference will now be described. It should be understood that for TDD systems, the downlink CSIT of the K users can be estimated from the uplink dedicated pilots due to channel reciprocity. Because uplink pilots are dedicated pilots per user and cannot be shared, the power allocated in the uplink pilots are usually smaller and the CSIT obtained at the base station is likely to be imperfect.

In contrast, the downlink pilot is shared by all the Customer Premises Equipment (CPEs) to estimate the downlink channel state. For example, in W-CDMA or CDMA2000 systems, there is a common downlink pilot channel transmitted by the base station that can be shared by all mobiles. Conversely, uplink pilots are dedicated per CPE and there will be one uplink pilot channel transmitted by one single CPE. As a result, compared to the downlink common pilot, the uplink dedicated pilots are usually allocated less power. Accordingly, the imperfect CSIT at a base station can be modeled as:

h_{k,m}^{b}=h_{k,m}+Δ_{k,m} Eqn. 2

where h_{k,m} can denote the actual CSI and Δ_{k,m} can denote the CSIT estimation error. Some existing cross-layer designs that attempt to address imperfect CSIT issues, assume that the base station has knowledge of CSIT error distribution as well as error variance σ_{Δ}². However, as described, this CSIT error information is difficult to obtain in practice. On the other hand, the downlink pilot channel (e.g., from a base station) is typically allocated more power because it can be shared by the K users. Accordingly, the CSI estimation at the mobile terminals (CSIR) can be quite accurate.

In addition, there may be interference from the surrounding cells. As a result, the interference experienced by the mobile stations can be very different than that measured at the base station. For simplicity, it can be assumed that the CSIR as well as interference power measurement at the mobile station is perfect for the detection of downlink packets. However, the base station has no knowledge about the mobile interference power βₖ of the K users as well as the variance of the CSIT errors σ_{Δ}². Advantageously, the disclosed subject matter, in various non-limiting embodiments can provide robust cross-layer scheduling without requiring knowledge of the CSIT error or knowledge of mobile interference statistics.

Based on the received signal model in Eqn. 1, the maximum achievable data rate of the k-th user in the m-th subcarrier and the n-th packet burst can be given by the maximum mutual information between Y_{k,m,n} and X_{m,n} conditioned on CSIR helm

$$\begin{matrix}{C}_{k , m , N} = {max}_{Pr ( {X}_{m , n} )} I ( {Y}_{k , m , n} ; {X}_{m , n} \vert {h}_{k , m} ) \\ = {log}_{2} ( 1 + {p}_{m , N} \frac{{\vert {h}_{k , m} \vert}^{2}}{{σ}_{z}^{2} / M + {β}_{k}^{2} / M} )\end{matrix} \qquad Eqn . 3$$

where p_{m,n} can denote the transmit power of the m-th subcarrier and the n-th packet burst. Although the maximum achievable rate (Shannon's capacity) is a theoretical limit, it can help to decouple the physical layer modeling from specific implementations of channel coding and modulations. In fact, for sufficiently strong coding such as turbo coding or LDPC coding, Shannon's capacity can be achieved within 0.05 dB.

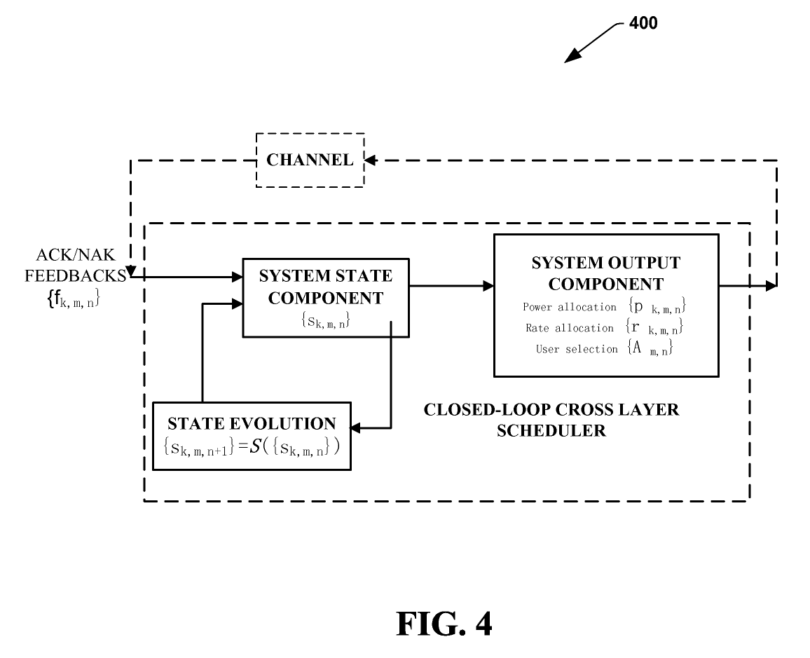

FIG. 4 illustrates an exemplary structure of a non-limiting embodiment of a closed-loop cross-layer scheduler 400 (e.g., MAC layer) according to various aspects of the disclosed subject matter. The disclosed subject matter, in various non-limiting embodiments thereof, can facilitate scheduling the radio resource at each scheduling slot based in part on the estimated CSIT h^{b}={h_{k,m}} for kε[1,K], mε[1,M] as well as the ACK/NAK feedback f_{k,m,n} ε{0, 1} (f_{k,m,n}=1 if an ACK is received from the k-th user after transmitting the n-th packet in the m-th subcarrier). According to an aspect of the disclosed subject matter, the outputs of a MAC scheduler can include a power allocation {p_{k,m,n}} and a rate allocation {r_{k,m,n}} as well as a user selection {A_{m,n}} output.

After packets in the first packet slot are transmitted, the selected mobile units can send ACK/NAK feedback to the base station before the next packet is delivered. For simplicity of illustration, it can be assumed that any delay of the ACK/NAK is small compared with the packet duration. According to a further aspect of the disclosed subject matter, for subsequent packet bursts in a scheduling slot, the cross-layer scheduler can adapt power allocation, rate allocation as well as user selection {p_{k,m,n}}, {r_{k,m,n}}, {A_{m,n}} for n>1 based on the CSIT and the ACK/NAK feedback from the mobile units.

A MAC layer scheduler, according to various embodiments of the disclosed subject matter, can be represented by a power allocation policy, a rate allocation policy, and a user selection policy, for example, as defined below.

A power allocation policy P={p_{k,m,n}} for kε[1,K], mε[1,M] and n ε[1,N] can be defined to be a set of causal power allocations p_{k,m,n}=p_{k,m,n}(h^{b}, f₁ⁿ⁻¹), where f₁ⁿ⁻¹ can denote the sequence of ACK/NAK feedback {f_{k,m}_{¹}, . . . , f_{k,m,n}_{^{−1}}}. In one aspect of the disclosed subject matter, the power allocations have to satisfy the average power constraint P₀:

Σ_{k,m,n}p_{k,m,n}≦P₀ Eqn. 4.1

Similarly, a rate allocation policy R={r_{k,m,n}} for kε[1,K], mε[1,M] and nε[1,N] can be defined to be a set of causal rate allocations:

r_{k,m,n}=r_{k,m,n}(h^{b},f₁ⁿ⁻¹) Eqn. 4.2

Similarly, a user selection policy A={A_{m,n}} for kε[1,K] and mε[1,M] is defined to be a set of causal user selections:

A_{m,n}={kε[1,K]:p_{k,m,n}>0}=A_{m,n}(h^{b},f₁ⁿ⁻¹) Eqn. 4.3

In addition, it should be appreciates that, one user can be selected per subcarrier. i.e. |A_{m,n}|≦1 for all m, n, where |A| denotes the cardinality of the set A.

Given the estimated CSIT h_{k,m}^{b} there can still be uncertainty on |h_{k,m}|² and as a result, the maximum achievable data rate C_{k,m,n} can appear as a random variable at a base station. Accordingly, packet transmission error (or packet transmission outage) can be possible when a scheduled data rate r_{k,m,n} exceeds the actual capacity C_{k,m,n}. When this happens, the transmit packet can be corrupted and packet error can occur despite the use of powerful error correction codes. According to further aspects of the disclosed subject matter, system goodput can be defined as below (e.g., which can measure the b/s/Hz successfully delivered to users), to facilitate accounting for the possibility of packet transmission error in the system.

Accordingly, r_{k,m,n} can be denoted as a scheduled data rate for user k in the m-th subcarrier and n-th packet. Thus, instantaneous goodput of the k-th user in the m-th subcarrier and n-th packet can be given by:

ρ_{k,m,n}=r_{k,m,n}1[C_{k,m,n}≧r_{k,m,n}] Eqn. 5

where 1 (E) can be an indicator function, which for example, can equal 1 if the event E is true and 0 otherwise. As a result, average total goodput, which can measure the average total b/s/Hz successfully delivered to the mobile units (e.g., averaged over ergodic realization of CSI), can be defined as:

$$\begin{matrix}U ( {P}_{0} , A , R , P ) = ɛ [ {\sum }_{n = 1}^{N} {\sum }_{m = 1}^{M} {ρ}_{{A}_{m , n} , m , n} ] \\ = {ɛ}_{{h}^{b}} \{ \begin{matrix}{\sum }_{n = 1}^{N} {\sum }_{m = 1}^{M} {ɛ}_{h \vert {h}^{b}} [ {r}_{{A}_{m , n} , m , n} 1 [ {C}_{{A}_{m , n} , m , n} \geq \\ {r}_{{A}_{m , n} , m , n} ] \vert {h}^{b} ]\end{matrix} \} \\ = {ɛ}_{{h}^{b}} \{ G ( {P}_{0} , {h}^{b} , A , R , P ) \}\end{matrix} \qquad Eqn . 6$$

where h can denote the actual channel coefficients; εₕ_{^{b}}[X] can denote the expectation of the random variable X with regard to h^{b}; A, R, P can denote causal user selection, rate allocation and power allocation policies as described above. G(P₀, h^{b}, A, R, P) can denote the conditional system goodput (e.g., conditioned on the estimated CSIT h^{b}). Accordingly, various non-limiting embodiments of the disclosed subject matter optimize the total average system goodput to account for the potential packet error due to imperfect CSIT and unknown interference.

Cross-Layer Algorithms and Methods for Systems with Imperfect CSIT and Unknown Interference

Referring again to FIG. 4 an exemplary structure of a non-limiting embodiment of a closed-loop cross-layer scheduler according to various aspects of the disclosed subject matter is illustrated. Accordingly, the disclosed subject matter can be described by a state-space structure which, in turn, can facilitate formulating scheduler designs as an optimization problem.

To that end, the scheduler can be characterized by an internal state Sₙ that can evolve based in part on the feedback of users (e.g., after each packet transmission). As a result, scheduler outputs (e.g., admitted users, power allocation, rate allocation) can be uniquely determined by the system state. The notations of FIG. 4 can be defined as follows: s_{k,m,n} can denote the state of user k in subcarrier m during the n-th packet burst and Sₙ={s_{k,m,n}}; ∀k,m can denote the collection of the states during the n-th packet burst; f_{k,m,n}={0,1} can denote the one-bit ACK/NAK feedback from the user k in the m-th subcarrier after the n-th packet is transmitted (e.g., f_{k,m,n}=1 if ACK is received and 0 otherwise). In addition, f₁ⁿ⁻¹ can denote the sequence of ACK/NAK feedback {f_{k,m,}_{¹}, . . . , f_{k,m,n}_{^{−1}}} for all mε[1,M] and kεA_{m,n}.

Thus, a causal state evolution policy S can be defined as:

s_{k,m,n}=S(Sₙ₋₁,fₙ₋₁) Eqn. 7

In addition, system outputs, including admitted users, power allocation and rate allocation policies, can be defined as functions of the current system state Sₙ:

p_{k,m,n}=P(Sₙ)∀k,m Eqn. 8

r_{k,m,n}=R(Sₙ)∀k,m Eqn. 9

A_{k,m,n}=A(Sₙ)∀k,m Eqn. 10

From Eqn. 3, actual Signal to Interference-plus-Noise Ratio (SINR) (with unit power)

$$\frac{{\vert {h}_{k , m} \vert}^{2}}{{σ}_{z}^{2} / M + {β}_{k}^{2} / M}$$

is a random variable with certain conditional Probability Density Function (PDF) q_{k,m,n}(x|f₁ⁿ⁻¹, h^{b}). Accordingly, the state s_{k,m,n}=[l_{k,m,n}, u_{k,m,n}] can be defined to be the lower bound and upper bound of the SINR given the knowledge of CSIT h^{b} and the ACK/NAK feedback f₁ⁿ⁻¹:

l_{k,m,n}=minₓ{x:q_{k,m,n}(x|f₁ⁿ⁻¹,h^{b})>0} Eqn. 11

and

u_{k,m,n}=maxₓ{x:q_{k,m,n}(x|f₁ⁿ⁻¹,h^{b})>0} Eqn. 12

According to an aspect of the disclosed subject matter, the conditional average system goodput G(P₀, h^{b}, A, R, P) as defined in Eqn. 6 can be optimized to take into consideration potential packet errors (e.g., given any realization of the imperfect CSIT). Because all user selection, power allocation, and rate allocation policies can be defined as functions of the system state Sₙ as well as the state evolution being denoted by S, the conditional average system goodput can be rewritten as G(P₀, h^{b}, A, R, P, S). As a result, from Eqn. 6, it can be shown that:

G(P₀,hⁿ,A,R,P,S)=ε_{A}_{₁}_{^{N}}Σₙ₌₁^{N} g̅ₙ(h^{b},Sₙ) Eqn. 13

where S₁^{N}={S₁, . . . , S_{N}}, g̅ₙ can denote the conditional average goodput (e.g., conditioned on CSIT h^{b} and current system state S_{N}) contributed by the n-th packet burst and can be given by:

g̅ₙ(h^{b},Sₙ)Σₘ₌₁^{M}=r_{A}_{_{m,n}}_{^{,m,n}}Pr[C_{A}_{_{m,n}}_{^{,m,n}}≧r_{A}_{_{m,n}}_{^{,m,n}}|h^{b},Sₙ] Eqn. 14

According to various embodiments of the disclosed subject matter, the closed-loop cross-layer scheduling problem with imperfect CSIT and unknown interference can be summarized as an optimization problem. For example, a cross-layer problem formulation for imperfect CSIT, can be summarized as follows. Given any realization of the estimated CSIT for all mobile users at all subcarriers h^{b}={h_{k,m}^{b}}, determine the optimal state evolution policy S, the optimal user selection policy {A(Sₙ)}, the optimal power allocation policy {P(Sₙ)}, and the optimal rate allocation policy {R(Sₙ)} such that the conditional total goodput, G(P₀, h^{b}, A, R, P, S) is maximized. That is:

G*(P₀,h^{b})=max_{A,R,P,S}ε_{S}_{₁}_{^{N}}{Σₙ₌₁^{N} g̅ₙ(h^{b},Sₙ)} Eqn. 15

where the power allocation, rate allocation policies are subject to constraints (e.g., Total Transmit Power Constraint Eqn. 4.1 and Quality of Service (QoS) Requirement). For example, a QoS can specify that conditional packet error probability of all the users is to be less than a target ε.

According to further aspects of the disclosed subject matter, optimal state evolution and the optimal system outputs can be derived for the above optimization problem (e.g., in two steps by first deriving optimal state evolution). For example, at a base station, Signal to Interference-plus-Noise Ratio (SINR) of user k in the m-th subcarrier and the n-th packet burst is a random variable with density q_{k,m,n} Accordingly, it can be shown that:

q_{k,m,n}(x)=q_{k,m,}_{¹}(x|f₁, . . . , fₙ_{^{−1}}) Eqn. 16

In the above equation, the event {f₁, . . . , fₙ_{^{−1}}} is equivalent to the event {LB_{k,m,n}≦x≦UB_{k,m,n}}, where

$$\begin{matrix}{LB}_{k , m , n} = {max}_{i} \{ \frac{{2}^{{r}_{k , m , i}} - 1}{{p}_{k , m , i}} : 1 \leq i \leq n - 1 and {f}_{k , m , i} = 1 \} & Eqn . 17 \\ and & \\ {UB}_{k , m , n} = {min}_{i} \{ \frac{{2}^{{r}_{k , m , i}} - 1}{{p}_{k , m , i}} : 1 \leq i \leq n - 1 and {f}_{k , m , i} = 0 \} & Eqn . 18\end{matrix}$$

Additionally, it can be shown that:

q_{k,m,n}(x)=q_{k,m,}_{¹}(LB_{k,m,n}≦x≦UB_{k,m,n}) Eqn. 19

l_{k,m,n}=LB_{k,m,n} Eqn. 20

According to a definition of the system state (e.g., Eqns. 11 and 12), the following results can be obtained:

u_{k,m,n}=UB_{k,m,n} Eqn. 21

Furthermore, from Eqns. 17 and 18 as well as the definition of the system state (e.g., Eqns. 11 and 12), the optimal state evolution in Eqn. 7 can be given by:

$$\begin{matrix}{l}_{k , m , n + 1} = \{ \begin{matrix}max \{ {l}_{k , m , n} , \frac{{2}^{{r}_{k , m , n}} - 1}{{p}_{k , m , n}} & if {f}_{k , m , n} = 1 , \{ k \} = {A}_{m , n} \\ {l}_{k , m , n} & otherwise .\end{matrix} & Eqn . 22 \\ and & \\ {u}_{k , m , n + 1} = \{ \begin{matrix}min \{ {u}_{k , m , n} , \frac{{2}^{{r}_{k , m , n}} - 1}{{p}_{k , m , n}} & if {f}_{k , m , n} = 0 , \{ k \} = {A}_{m , n} \\ {u}_{k , m , n} & otherwise .\end{matrix} & Eqn . 23\end{matrix}$$

Accordingly, the optimal system output equations (e.g., user selection in Eqn. 10, power allocation in Eqn. 8 and rate allocation policies in Eqn. 9) can be derived in terms of the current system state Sₙ. Moreover, according to further aspects of the disclosed subject matter, optimization objective G(P₀, h^{b}, A, R, P, S) can be divided and conquered into a set of recursive equations.

This recursive relation can be summarized as follows. For example, to prove a recursive formulation of the conditional goodput, let Fₙ*(P, h^{b}, Sₙ) be the total optimal average goodput from the n-th packet burst to the N-th packet burst conditioned on the CSIT and the system state Sₙ.

Fₙ*(P,h^{b},Sₙ)=max_{{A}_{_{m,n}}_{},{p}_{_{k,m,n}}_{},{r}_{_{k,m,n}}_{}}{ g̅ₙ(pₙ,h^{b},Sₙ)+Σᵢ₌ₙ₊₁^{N}Σ_{S}_{ₙ₊₁}Pr(Sₙ₊₁|Sₙ,h^{b}) g̅₁(pᵢ,h^{b},Sᵢ)} Eqn. 24

subject to

Σᵢ₌ₙ^{N}Σₘ₌₁^{M}p_{k,m,n}=P for {k}=A_{m,n} Eqn. 25

Thus, Fₙ*(P, h^{b}, Sₙ) can be expressed recursively as:

$${F}_{n}^{*} ( P , {h}^{b} , {S}_{n} ) = {max}_{{\{ {p}_{k , m , n} \}}_{{\{ {r}_{k , m , n} \}}_{\{ {A}_{m , n} \}}}} \{ \begin{matrix}{\overline{g}}_{n} ( {p}_{n} , {h}^{b} , {S}_{n} ) + \\ {\sum }_{{S}_{n + 1}} Pr ( {S}_{n + 1} \vert {S}_{n} , {h}^{b} ) {F}_{n + 1}^{*} ( P - {p}_{n} , {h}^{b} , {S}_{n + 1} )\end{matrix} \} \qquad Eqn . 26$$

where

pₙ=Σₘ₌₁^{M}p_{k,m,n} for {k}=A_{m,n}

for all nε[1,N] and Fₙ₊₁*=0. Hence, the optimal conditional goodput in Eqn. 15 can be given by

G*(P₀,h^{b})=F₁*(P₀,h^{b}) Eqn. 27

As a result of recursive formulation of the conditional goodput, the optimization problem with respect to {A_{m,n}}, {p_{k,m,n}}, {r_{k,m,n}} (e.g., given any CSIT realization h^{b} and current system state Sₙ) can be divided and conquered into N steps.

The recursive equation in Eqn. 26 is also called the Bellmen's equation for which the optimization problem belongs to the class of Markov decision problems. The general solution for the class of Markov decision problem typically involves an offline recursion and an online strategy.

Accordingly, in various non-limiting embodiments of the disclosed subject matter, the offline recursion can facilitate determining user selection, power allocation, and rate allocation policies for all system states. It is to be appreciated that although the offline recursion is typically not a real-time process, the online strategy is a real-time algorithm which facilitates selecting the optimal user, power, and rate allocation for the n-th packet burst after updating the current system state according to the latest ACK/NAK feedback from the mobile units.

In the offline strategy, the optimization for the average goodput G*(P, h^{b}) with respect to the user selection policy, {A_{m,n}}, the power allocation policy, {p_{k,m,n}} and the rate allocation policy, {r_{k,m,n}}, (for the N packet bursts) can be partitioned into N recursive optimizations using the recursive relationship of Fₙ* and Fₙ₊₁* in Eqn. 26. Advantageously, according to various non-limiting embodiments of the disclosed subject matter, the optimal policies can be used for the online algorithm when the actual ACK/NAK feedback are received.

Accordingly, the offline recursive solution can be described as follows. First, consider the last packet burst n=N. Recall that the channel capacity can be given by:

$${C}_{k , m , N} = {log}_{2} ( 1 + {p}_{k , m , N} \frac{{\vert {h}_{k , m} \vert}^{2}}{{σ}_{z}^{2} / M + {β}_{k}^{2} / M} ) \qquad Eqn . 28$$

where

$$\frac{{\vert {h}_{k , m} \vert}^{2}}{{σ}_{z}^{2} / M + {β}_{k}^{2} / M}$$

is a random variable with density q_{k,m,N}(x). Q_{k,m,N}(x) can denote the corresponding cumulative distribution function. To satisfy the packet error requirement (ε), the scheduled data rate can be given by:

r_{k,m,N}=log₂(1+p_{k,m,N}θ_{k,m,N}) Eqn. 29

where θ_{k,m,N} is the SINR scaling factor given by:

θ_{k,m,N}=Q_{k,m,N}⁻¹(ε) Eqn. 30

To determine the optimal power allocation policies, {p_{k,m,N}}, the Lagrangian can be formed as:

L=Σₘ₌₁^{M}(1−ε)log₂(1+p_{k,m,N}θ_{k,m,N})−λ_{N}Σₘ₌₁^{M}p_{k,m,N}

for {k}=A_{m,n} Eqn. 31

Using standard optimization techniques, the optimal power allocation policy can be given by:

$${p}_{k , m , N}^{*} = {( \frac{1}{{λ}_{N}} - \frac{1}{{θ}_{k , m , N}} )}^{+} for \{ k \} = {A}_{m , n} \qquad Eqn . 32$$

where (X)⁺=max(0,X), λ_{N} is the Lagrangian multiplier given by:

$$\frac{1}{{λ}_{N}} = \frac{1}{M} ( {p}_{N} {\sum }_{m = 1}^{M} \frac{1}{{θ}_{k , m , N}} ) for \{ k \} = {A}_{m , n} \qquad Eqn . 33$$

for sufficiently large p_{N}. Finally, substituting Eqns. 32 and 33 into the objective function F_{N}*(p_{N}) Eqn. 24, the optimal user selection can be given by:

A_{m,N}=arg maxₖ{θ_{k,m,N}} Eqn. 34

Hence, the closed form for F_{N}*(p_{N}) can be given by:

$${F}_{N}^{*} ( {p}_{N} ) = {\overline{g}}_{N}^{*} ( {p}_{N} ) = ( 1 - ε ) {{log}_{2} ( {p}_{N} + {\sum }_{m = 1}^{M} \frac{1}{{θ}_{k , m , N}} )}^{M} + ( 1 - ε ) {log}_{2} \frac{{\prod }_{m = 1}^{M} {θ}_{k , m , N}}{{M}^{M}} for \{ k \} = {A}_{m , n} \qquad Eqn . 35$$

Because {θ_{k,m,N}} are functions of S_{N}, the equations Eqns. 34, 32, and 29 can give the optimal user selection, power allocation, and rate allocation in terms of the system state.

As a second step in an offline recursive solution, consider the packet burst n, where n={N−1,N−2, . . . 1}. Given the target error probability ε, the state transition probability Pr(Sₙ_{⁺¹}|Sₙ, h^{b}) in Eqn. 26 has the form of (1−ε)^{a}ε^{b}, where a is the total number of ACK feedback and b is the total number of NAK feedback after the transmission of the n-th packet. Since E is usually chosen to be very small, most of state transition probabilities are very small except the one when a=|A| and b=0 (e.g., there is no transmission error). Accordingly, it can be shown that:

Fₙ*(P,h^{b},Sₙ)≈max_{{p}_{_{k,m,n}}_{},{r}_{_{k,m,n}}_{},{A}_{_{m,n}}_{},}{ g̅ₙ(P,h^{b},Sₙ)+Fₙ₋₁*(P−pₙ,h^{b},Sₙ₊₁)} Eqn. 36

where the state Sₙ_{⁺¹} is derived from its previous state Sₙ based on the ACK/NAK feedback in Eqns. 22 and 23.

Similar to the first step in an offline recursive solution, the optimal power and rate allocation policies can be given by:

$$\begin{matrix}{p}_{k , m , n} = {( \frac{1}{{λ}_{n}} - \frac{1}{{θ}_{k , m , n}} )}^{+} for \{ k \} = {A}_{m , n} & Eqn . 37 \\ {r}_{k , m , n} = {log}_{2} ( 1 + {p}_{k , m , n} {θ}_{k , m , n} ) & Eqn . 38 \\ where & \\ \frac{1}{{λ}_{n}} = \frac{1}{M} ( {p}_{n} {\sum }_{m = 1}^{M} \frac{1}{{θ}_{k , m , n}} ) for \{ k \} = {A}_{m , n} & Eqn . 39 \\ and & \\ {p}_{n} = \frac{P}{N - n + 1} + \frac{1}{N - n + 1} {\sum }_{i = n}^{N} {\sum }_{m = 1}^{M} \frac{1}{{θ}_{{A}_{m , i} , m , i}} - {\sum }_{m = 1}^{M} \frac{1}{{θ}_{k , m , n}} for \{ k \} = {A}_{m , n} & Eqn . 40\end{matrix}$$

Thus, according to various embodiments of the disclosed subject matter, the optimal user selection can be given as follows. To determine an optimal user selection, s_{k,m,n}_{⁺¹}, . . . , s_{k,m,N} can denote the system states evolved from s_{k,m,n} and θ_{k,m,n}, . . . , θ_{k,m,N} can denote the corresponding SINR scaling factors. Thus, an optimal admitted user in the m-th subcarrier and the n-th packet burst can be given by:

A_{m,n}=arg maxₖπᵢ₌ₙ^{N}{θ_{k,m,i}} Eqn. 41

Accordingly, it can be shown that

$${F}_{n}^{*} ( P , {h}^{b} , {S}_{n} ) = ( 1 - ε ) {{log}_{2} ( \frac{P}{N - n + 1} + \frac{{\sum }_{i = n}^{N} {\sum }_{m = 1}^{M} \frac{1}{{θ}_{{A}_{m , i} , m , i}}}{N - n + 1} )}^{( N - n + 1 ) M} + ( 1 - ε ) {log}_{2} ( \frac{{\prod }_{i = n}^{N} {\prod }_{m = 1}^{M} {θ}_{{A}_{m , i} , m , i}}{{M}^{( N - n + 1 ) M}} ) \qquad Eqn . 42$$

As described above, the online strategy is a real-time algorithm. For instance, upon receiving the specific ACK/NAK feedback fₙ, the system state Sₙ can be updated to Sₙ_{⁺¹} by Eqn. 7, according to an aspect of the disclosed subject matter. According to a further aspect of the disclosed subject matter, based in part on the updated system state Sₙ_{⁺¹} and optimal policies {A_{m,n}}, {p_{k,m,n}}, and {p_{k,m,n}} (e.g., obtained in the offline backward recursion), select the optimal users, the optimal power and rate allocation. For example, the online processing can be described as follows.

At the first packet burst, the optimal users, power, and rate allocation {A_{m,}_{¹}}, {p_{k,m,}_{¹}} and {p_{k,m,}_{¹}} based on the estimated CSIT h^{b} is obtained according to Eqns. 41, 37, and 38. Next, before transmitting the n+1-th packet burst (n={1, 2, . . . , N−1}), the base station can obtain any ACK/NAK feedback of the previous packet fₙ and can update the system state accordingly. Thus, optimal user selection, power, and rate allocation for the n+1-th packet can be obtained from Eqns. 41, 37, and 38 and Eqns. 34, 32, and 29 determined in an offline recursion.

The convergence of the system state can be summarized as follows. For sufficiently large n and quasi-static fading channel, it can be shown that:

$${lim}_{n \to ∞} {A}_{m , n} = arg {max}_{k} \frac{{\vert {h}_{k , m} \vert}^{2}}{{σ}_{z}^{2} / M + {β}_{k}^{2} / M} \qquad Eqn . 43$$

Furthermore, if a user j has the largest SINR in the m-th subcarrier, it can be shown that:

$${lim}_{n \to ∞} {A}_{j , m , n} = arg {max}_{k} \frac{{\vert {h}_{j , m} \vert}^{2}}{{σ}_{z}^{2} / M + {β}_{j}^{2} / M} \qquad Eqn . 44$$

In other words, for sufficiently large n, the system state of the user with largest SINR will converge to the actual SINR and the user selection will converge to the best user selection (as if perfect CSIT were available).

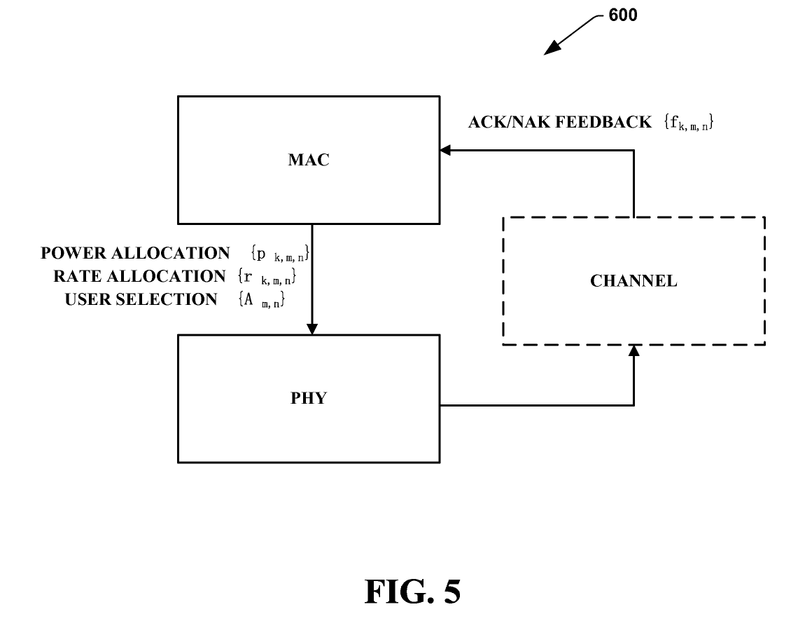

FIG. 5 illustrates a block diagram of an exemplary non-limiting device that facilitates cross-layer scheduling according to various aspects of the disclosed subject matter.

For example, device according to various aspects of the disclosed subject matter can comprise a media access control layer component and a physical layer component. The media access control layer component can receive acknowledgement and negative acknowledgement traffic in response to packets sent from the physical layer component, as described above, in addition, being able to update the device state in response to receiving the traffic. Additionally, the media access control layer component can communicate with the physical layer component, for example to control power allocation, rate allocation, and user selection by the physical layer component according to device state and a scheduling policy.

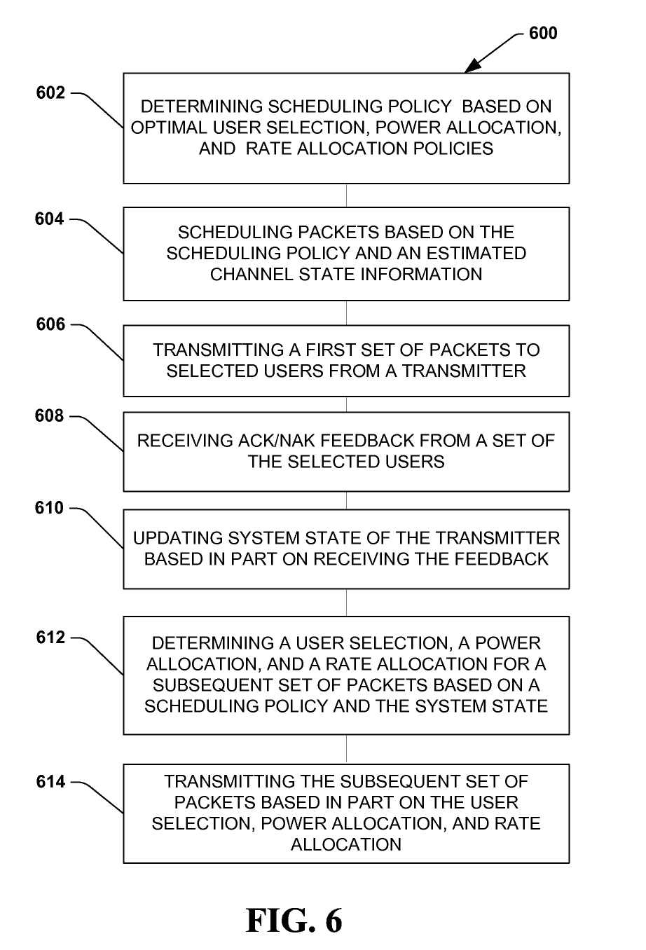

In view of the exemplary systems and devices described supra, methodologies that can be implemented in accordance with the disclosed subject matter will be better appreciated with reference to the flowchart of FIG. 6. While for purposes of simplicity of explanation, the communication processes and methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks may be required to implement the methodologies described hereinafter.

FIG. 6 illustrates an exemplary non-limiting high level methodology 500 according to various aspects of the disclosed subject matter. At 602, a scheduling policy can be determined. For example, the scheduling policy can be based in part on an optimal user selection policy, an optimal power allocation policy, and an optimal rate allocation policy. In addition, at 604, a first set of packets can be scheduled based in part on the scheduling policy and an estimated channel state information at the transmitter. At 606, the first set of packets can be transmitted to selected users from a transmitter, for example based on schedule. At 608, feedback can be received including acknowledgement and negative acknowledgement traffic from a set of the selected users. Additionally, at 610, transmitter system state can be updated based in part on receiving the feedback. In addition, at 612, a user selection, a power allocation, and a rate allocation can be determined for a subsequent set of packets based in part on a scheduling policy and the system state. For example, the updated state can be used to update the packet schedule. At 614, the subsequent set of packets can be transmitted based in part on the user selection, power allocation, and rate allocation.

### Performance of Selected Closed Loop Cross-Layer Scheduler Embodiments on Static Channel

In this section, performance of various non-limiting embodiments of the closed-loop cross-layer scheduler design is depicted. Accordingly, the number of users K is 5, the number of multipaths Lₚ is 4, and the target packet error probability ε is 0.01 in the simulations. For simplicity, it is assumed that the unknown interference power βₖ² of each user is the same. The unknown interference taken to be quasi-static within a scheduling slot but random between scheduling slots according to U(0, I). In the simulation, the actual CSI has been generated according to complex Gaussian distribution CN(0, 1).

It is further assumed that the base station does not have any knowledge on the actual interference power β, actual distribution of the SINR, as well as the actual CSIT estimation error σ_{Δ}². In addition, the base station has default values for these parameters (β=1, σₑ²=0.5) which is not the same as the actual parameters. Thus it is shown by simulation that although the default parameters are not equal to the actual parameters, the system state, according to various aspects of the disclosed subject matter, can still converge to the actual SINR. In addition, it can be seen that the closed-loop system can be very robust with respect to the mismatch even in high CSIT error and high interference power. Each point in the resulting figures has been obtained by averaging over 1000 independent fading realizations.

As used in herein, the term “open loop” is intended to refer to cross-layer designs based on the imperfect CSIT knowledge obtained at the beginning of scheduling slot only. Perfect CSIT is in intended to refer to ideal systems with perfect CSIT, and which can serve as performance upper bound for bench marking. Round robin scheduler is intended to refer to naive cross-layer design assuming the CSIT is perfect while selecting a user randomly, while a naive scheduler is intended to refer to a cross-layer scheduler assuming the CSIT is perfect.

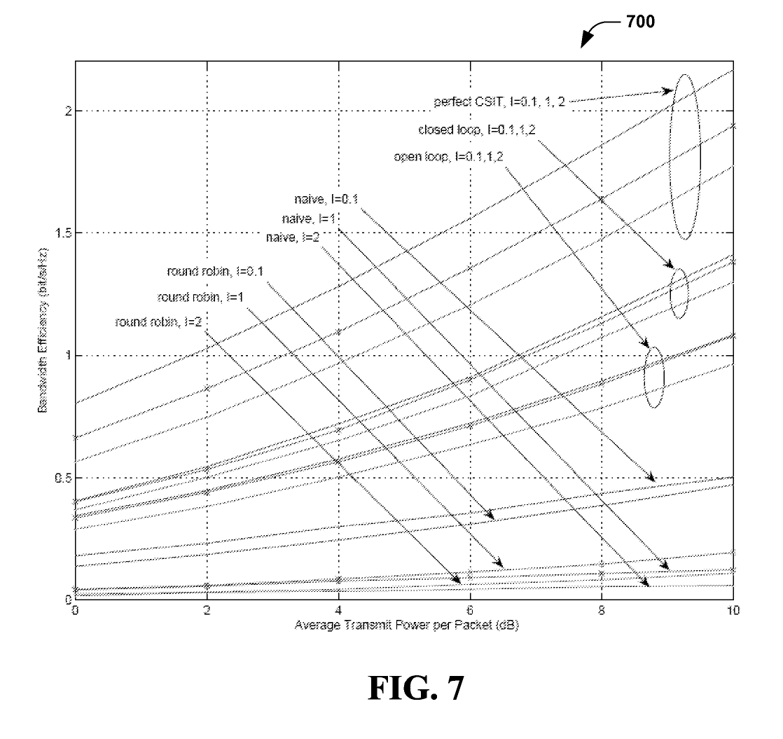

FIG. 7 depicts average goodput performance versus transmit power according to various embodiments of the disclosed subject matter. For example, considering the case of slow fading in which the channel fading is quasi-static within a scheduling slot, FIG. 7 depicts the average system goodput versus the transmit power of the proposed closed-loop scheduler at high CSIT errors σ_{ΔH}²=0.1, M=4 and the maximum unknown interference power I=0.1, 1, 2. For comparison, the non-limiting embodiments of the disclosed subject matter are compared with various baselines, namely the open-loop cross layer scheduler, the naive scheduler (designed assuming perfect CSIT) and round robin scheduler. The open-loop scheduler, the round robin scheduler and the naive scheduler are considered as open-loop designs due to the fact that the designs do not exploit the ACK/NAK feedback from the mobile units. The exemplary non-limiting embodiments of the closed-loop scheduler achieves a significant performance gain over the baseline reference schedulers. This illustrates that with the ACK/NAK feedback, significant cross-layer gains can be achieved even at large CSIT errors and large unknown interference. The disclosed embodiments can also be seen to be robust to mismatch in the channel statistics and parameters.

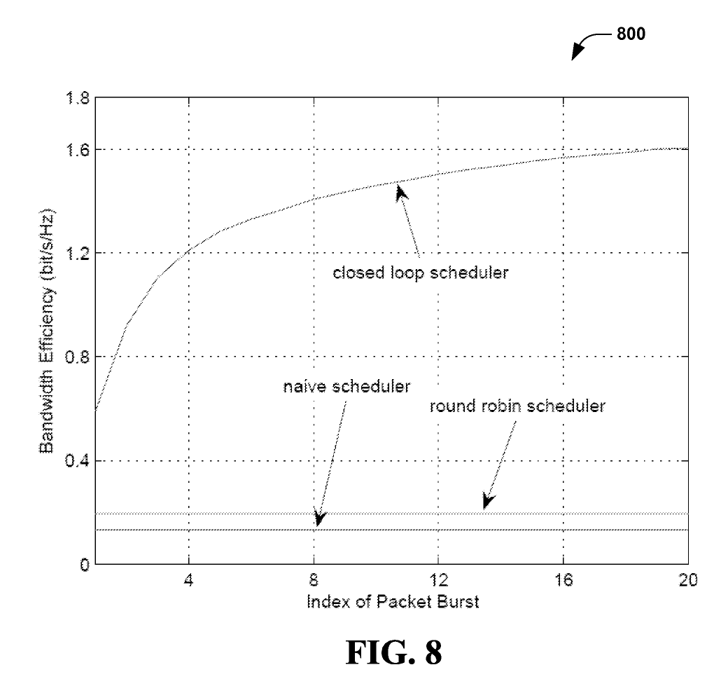

FIG. 8 depicts average goodput performance of packet bursts according to various embodiments of the disclosed subject matter. For example, FIG. 8 depicts the average goodput of each packet burst (e.g., averaged over multiple scheduling slots) at high CSIT errors σ_{ΔH}²=0.1, I=1, M=4 and P₀=23 decibel (dB). It can be seen that the average goodput of the closed-loop scheduler increases with the packet burst index. According to an aspect of the disclosed subject matter, the scheduler can get better estimation of the actual SINR at later packet slots after receiving more ACK/NAK feedback advantageously resulting in more accurate decisions of user selection made in the later packet slots. Since the scheduler can explore more multiuser diversity in the later packet bursts, it follows that the performance is improved.

According to a further aspect of the disclosed subject matter, because the CSIT is more accurate in the later packet slots, more power can be allocated to the later slots to explore the performance gain of multiuser diversity. As should be appreciated, the two reference schedulers do not have such behavior because the knowledge of the actual SINR remains constant at all packet slots.

### Performance Sensitivity of Selected Embodiments on Doppler Spread

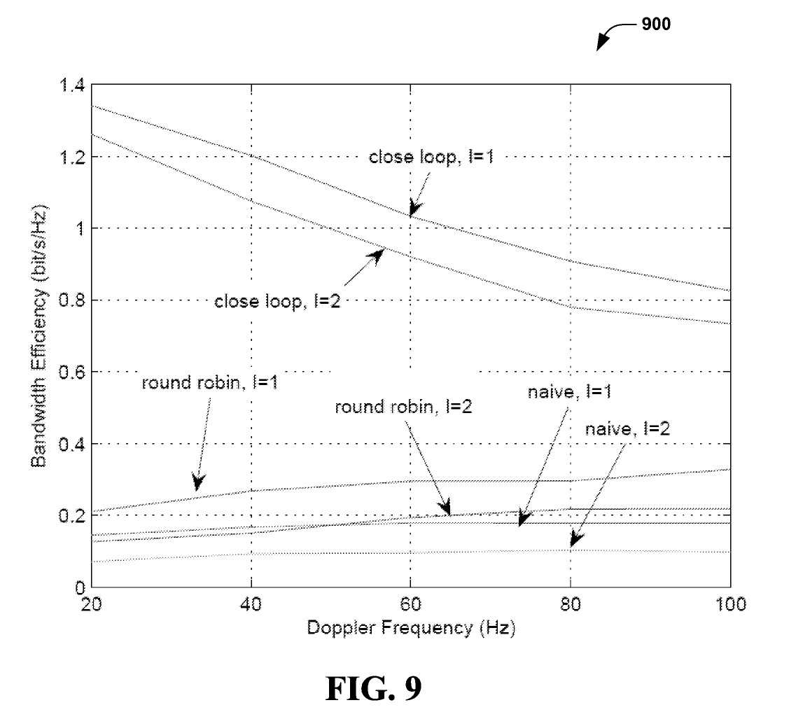

FIG. 9 depicts the average goodput performance versus Doppler frequency according to various embodiments of the disclosed subject matter.

In this part, frequency selective fading channels with Doppler frequency f_{d} from 20 Hz to 100 Hz are considered, which can corresponds to a speed of 9 and 45 km/hr at 2.4 GHz respectively. In addition, the duration of the packet slot is 0.2 ms. FIG. 5 illustrates the average system goodput versus the Doppler frequency of various non-limiting embodiments of a closed-loop scheduler, a round robin scheduler, and a naive scheduler at large CSIT errors σ_{ΔH}²=0.1, I=1, 2, M=4 and P₀=23 dB respectively. It can be observed that significant gain of various non-limiting embodiments of the closed-loop cross-layer design can be achieved at moderate to large Doppler frequency.

### Convergence of Selected Embodiments a Close Loop Adaptation

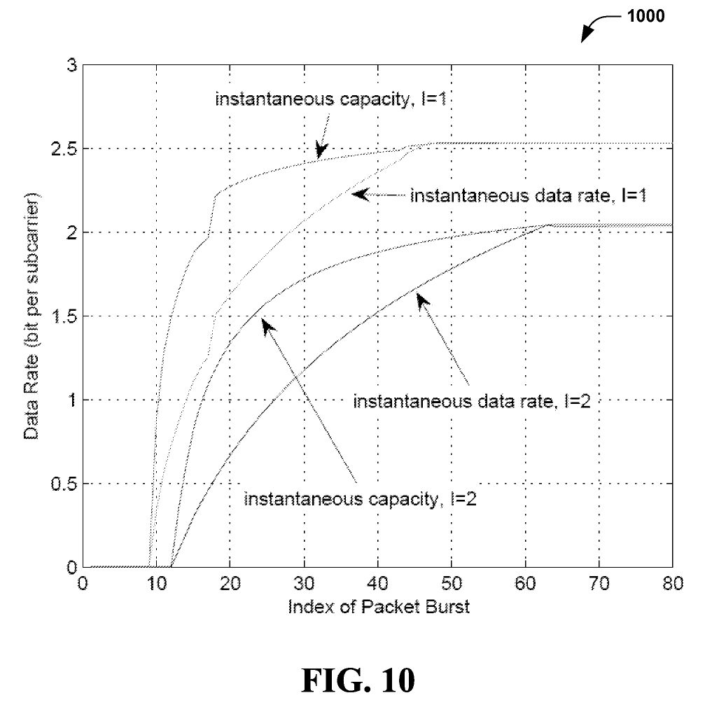

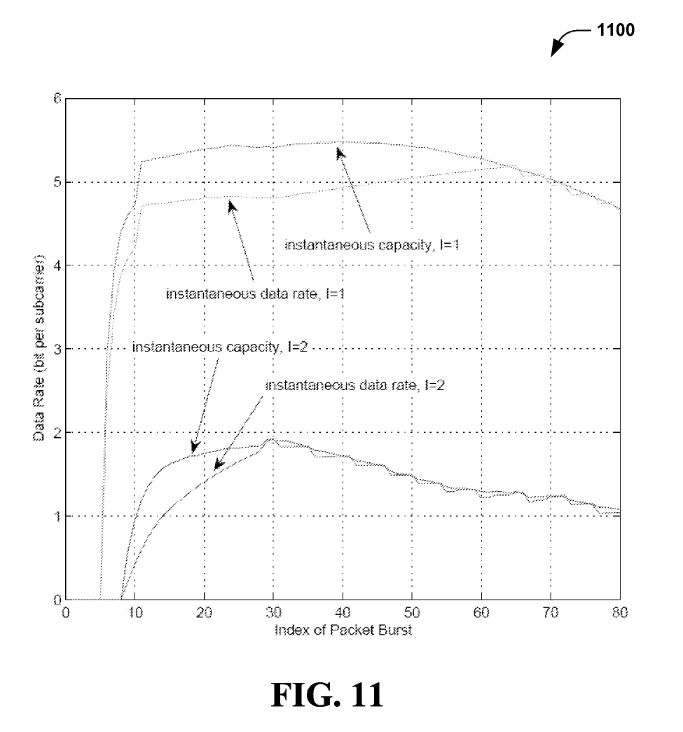

FIGS. 10 and 11 depict the transient of the instantaneous scheduled data rate and the actual instantaneous channel capacity versus time (packet slot) according to particular embodiments of the disclosed subject matter (f_{d}=0 Hz and f_{d}=20 Hz respectively) with high CSIT errors σ_{ΔH}²=0.1 and high interference I=1, 2. In the simulation, M=4, K=1 and P₀=29 dB. In both cases, the scheduled data rate of various non-limiting embodiments of the closed loop cross-layer designs advantageously converge to the instantaneous actual capacity. As a result, it can be seen that the disclosed subject matter can provide robust cross layer scheduling with respect to the CSIT error, unknown interference, model mismatch and the channel variation due to Doppler.

### Exemplary Computer Networks and Environments

One of ordinary skill in the art can appreciate that the disclosed subject matter can be implemented in connection with any computer or other client or server device, which can be deployed as part of a communications system, a computer network, or in a distributed computing environment, connected to any kind of data store. In this regard, the disclosed subject matter pertains to any computer system or environment having any number of memory or storage units, and any number of applications and processes occurring across any number of storage units or volumes, which may be used in connection with communication systems using the cross layer scheduling algorithms, methods, and systems in accordance with the disclosed subject matter. The disclosed subject matter may apply to an environment with server computers and client computers deployed in a network environment or a distributed computing environment, having remote or local storage. The disclosed subject matter may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the communication systems using the cross layer scheduling algorithms, methods, and systems of the disclosed subject matter.

FIG. 12 provides a schematic diagram of an exemplary networked or distributed computing environment. The distributed computing environment comprises computing objects 1210a, 1210b, etc. and computing objects or devices 1220a, 1220b, 1220c, 1220d, 1220e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1240. This network may itself comprise other computing objects and computing devices that provide services to the system of FIG. 12, and may itself represent multiple interconnected networks. In accordance with an aspect of the disclosed subject matter, each object 1210a, 1210b, etc. or 1220a, 1220b, 1220c, 1220d, 1220e, etc. may contain an application that might make use of an API, or other object, software, firmware and/or hardware, suitable for use with the design framework in accordance with the disclosed subject matter.

It can also be appreciated that an object, such as 1220c, may be hosted on another computing device 1210a, 1210b, etc. or 1220a, 1220b, 1220c, 1220d, 1220e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for communicating information used in the communication systems using the cross layer scheduling algorithms, methods, and systems according to the disclosed subject matter.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 12, as an example, computers 1220a, 1220b, 1220c, 1220d, 1220e, etc. can be thought of as clients and computers 1210a, 1210b, etc. can be thought of as servers where servers 1210a, 1210b, etc. maintain the data that is then replicated to client computers 1220a, 1220b, 1220c, 1220d, 1220e, etc., although any computer can be considered a client, a server, or both, depending on the circumstances. Any of these computing devices may be processing data or requesting services or tasks that may use or implicate the communication systems using the cross layer scheduling algorithms, methods, and systems in accordance with the disclosed subject matter.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to communication (e.g., either wired or wireless) using the cross layer scheduling algorithms, methods, and systems of the disclosed subject matter may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 12 illustrates an exemplary networked or distributed environment, with server(s) in communication with client computer (s) via a network/bus, in which the disclosed subject matter may be employed. In more detail, a number of servers 1210a, 1210b, etc. are interconnected via a communications network/bus 1240, which may be a LAN, WAN, intranet, GSM network, the Internet, etc., with a number of client or remote computing devices 1220a, 1220b, 1220c, 1220d, 1220e, etc., such as a portable computer, handheld computer, thin client, networked appliance, or other device, such as a VCR, TV, oven, light, heater and the like in accordance with the disclosed subject matter. It is thus contemplated that the disclosed subject matter may apply to any computing device in connection with which it is desirable to communicate data over a network.

In a network environment in which the communications network/bus 1240 is the Internet, for example, the servers 1210a, 1210b, etc. can be Web servers with which the clients 1220a, 1220b, 1220c, 1220d, 1220e, etc. communicate via any of a number of known protocols such as HTTP. Servers 1210a, 1210b, etc. may also serve as clients 1220a, 1220b, 1220c, 1220d, 1220e, etc., as may be characteristic of a distributed computing environment.

As mentioned, communications to or from the systems incorporating the cross layer scheduling algorithms, methods, and systems of the disclosed subject matter may ultimately pass through various media, either wired or wireless, or a combination, where appropriate. Client devices 1220a, 1220b, 1220c, 1220d, 1220e, etc. may or may not communicate via communications network/bus 12, and may have independent communications associated therewith. For example, in the case of a TV or VCR, there may or may not be a networked aspect to the control thereof. Each client computer 1220a, 1220b, 1220c, 1220d, 1220e, etc. and server computer 1210a, 1210b, etc. may be equipped with various application program modules or objects 1235a, 1235b, 1235c, etc. and with connections or access to various types of storage elements or objects, across which files or data streams may be stored or to which portion(s) of files or data streams may be downloaded, transmitted or migrated. Any one or more of computers 1210a, 1210b, 1220a, 1220b, 1220c, 1220d, 1220e, etc. may be responsible for the maintenance and updating of a database 1230 or other storage element, such as a database or memory 1230 for storing data processed or saved based on communications made according to the disclosed subject matter. Thus, the disclosed subject matter can be utilized in a computer network environment having client computers 1220a, 1220b, 1220c, 1220d, 1220e, etc. that can access and interact with a computer network/bus 1240 and server computers 1210a, 1210b, etc. that may interact with client computers 1220a, 1220b, 1220c, 1220d, 1220e, etc. and other like devices, and databases 1230.

### Exemplary Computing Device

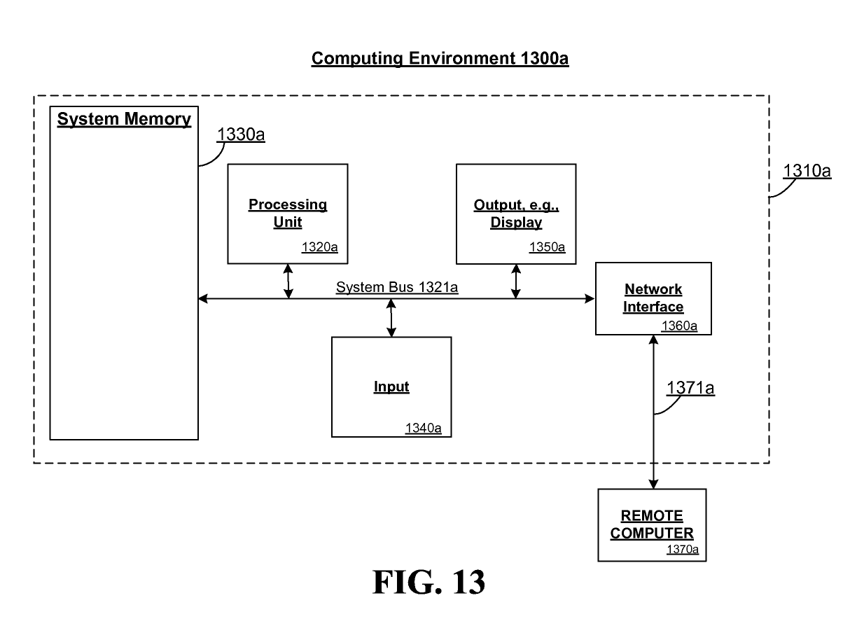

As mentioned, the disclosed subject matter applies to any device wherein it may be desirable to communicate data, e.g., to or from a mobile device. It should be understood, therefore, that handheld, portable and other computing devices and computing objects of all kinds are contemplated for use in connection with the disclosed subject matter, i.e., anywhere that a device may communicate data or otherwise receive, process or store data. Accordingly, the below general purpose remote computer described below in FIG. 13 is but one example, and the disclosed subject matter may be implemented with any client having network/bus interoperability and interaction. Thus, the disclosed subject matter may be implemented in an environment of networked hosted services in which very little or minimal client resources are implicated, e.g., a networked environment in which the client device serves merely as an interface to the network/bus, such as an object placed in an appliance.

Although not required, the some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules, being executed by one or more computers, such as client workstations, servers or other devices. Those skilled in the art will appreciate that the disclosed subject matter may be practiced with other computer system configurations and protocols.

FIG. 13 thus illustrates an example of a suitable computing system environment 1300a in which some aspects of the disclosed subject matter may be implemented, although as made clear above, the computing system environment 1300a is only one example of a suitable computing environment for a media device and is not intended to suggest any limitation as to the scope of use or functionality of the disclosed subject matter. Neither should the computing environment 1300a be interpreted as having any dependency or requirement relating to any one or combination of components illustrated in the exemplary operating environment 1300a.

With reference to FIG. 13, an exemplary remote device for implementing the disclosed subject matter includes a general purpose computing device in the form of a computer 1310a. Components of computer 1310a may include, but are not limited to, a processing unit 1320a, a system memory 1330a, and a system bus 1321a that couples various system components including the system memory to the processing unit 1320a. The system bus 1321a may be any of several types of bus structures including a memory bus or memory controller, a peripheral bus, and a local bus using any of a variety of bus architectures.

Computer 1310a typically includes a variety of computer readable media. Computer readable media can be any available media that can be accessed by computer 1310a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1310a. Communication media typically embodies computer readable instructions, data structures, program modules or other data in a modulated data signal such as a carrier wave or other transport mechanism and includes any information delivery media.

The system memory 1330a may include computer storage media in the form of volatile and/or nonvolatile memory such as read only memory (ROM) and/or random access memory (RAM). A basic input/output system (BIOS), containing the basic routines that help to transfer information between elements within computer 1310a, such as during start-up, may be stored in memory 1330a. Memory 1330a typically also contains data and/or program modules that are immediately accessible to and/or presently being operated on by processing unit 1320a. By way of example, and not limitation, memory 1330a may also include an operating system, application programs, other program modules, and program data.

The computer 1310a may also include other removable/non-removable, volatile/nonvolatile computer storage media. For example, computer 1310a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1321a through a non-removable memory interface such as an interface, and a magnetic disk drive or optical disk drive is typically connected to the system bus 1321a by a removable memory interface, such as an interface.

A user may enter commands and information into the computer 1310a through input devices such as a keyboard and pointing device, commonly referred to as a mouse, trackball or touch pad. Other input devices may include a microphone, joystick, game pad, satellite dish, scanner, wireless device keypad, voice commands, or the like. These and other input devices are often connected to the processing unit 1320a through user input 1340a and associated interface(s) that are coupled to the system bus 1321a, but may be connected by other interface and bus structures, such as a parallel port, game port or a universal serial bus (USB). A graphics subsystem may also be connected to the system bus 1321a. A monitor or other type of display device is also connected to the system bus 1321a via an interface, such as output interface 1350a, which may in turn communicate with video memory. In addition to a monitor, computers may also include other peripheral output devices such as speakers and a printer, which may be connected through output interface 1350a.

The computer 1310a may operate in a networked or distributed environment using logical connections to one or more other remote computers, such as remote computer 1370a, which may in turn have media capabilities different from device 1310a. The remote computer 1370a may be a personal computer, a server, a router, a network PC, a peer device, personal digital assistant (PDA), cell phone, handheld computing device, or other common network node, or any other remote media consumption or transmission device, and may include any or all of the elements described above relative to the computer 1310a. The logical connections depicted in FIG. 13 include a network 1371a, such local area network (LAN) or a wide area network (WAN), but may also include other networks/buses, either wired or wireless. Such networking environments are commonplace in homes, offices, enterprise-wide computer networks, intranets and the Internet.

When used in a LAN networking environment, the computer 1310a is connected to the LAN 1371a through a network interface or adapter. When used in a WAN networking environment, the computer 1310a typically includes a communications component, such as a modem, or other means for establishing communications over the WAN, such as the Internet. A communications component, such as a modem, which may be internal or external, may be connected to the system bus 1321a via the user input interface of input 1340a, or other appropriate mechanism. In a networked environment, program modules depicted relative to the computer 1310a, or portions thereof, may be stored in a remote memory storage device. It will be appreciated that the network connections shown and described are exemplary and other means of establishing a communications link between the computers may be used.

While the disclosed subject matter has been described in connection with the preferred embodiments of the various Figures, it is to be understood that other similar embodiments may be used or modifications and additions may be made to the described embodiment for performing the same function of the disclosed subject matter without deviating therefrom. For example, one skilled in the art will recognize that the disclosed subject matter as described in the present application applies to communication systems using the disclosed cross layer scheduling algorithms, methods, and systems and may be applied to any number of devices connected via a communications network and interacting across the network, either wired, wirelessly, or a combination thereof. In addition, it is understood that in various network configurations, access points may act as nodes and nodes may act as access points for some purposes. Therefore, the disclosed subject matter should not be limited to any single embodiment, but rather should be construed in breadth and scope in accordance with the appended claims.

### Exemplary Communications Networks and Environments

The above-described communication systems using the cross layer scheduling algorithms, methods, and systems may be applied to any network, however, the following description sets forth some exemplary telephony radio networks and non-limiting operating environments for communications made incident to the communication systems using the cross layer scheduling algorithms, methods, and systems of the disclosed subject matter. The below-described operating environments should be considered non-exhaustive, however, and thus the below-described network architecture merely shows one network architecture into which the disclosed subject matter may be incorporated. One can appreciate, however, that the disclosed subject matter may be incorporated into any now existing or future alternative architectures for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the cross layer scheduling algorithms, methods, and systems of the disclosed subject matter may be applied independently of the method of data transport, and does not depend on any particular network architecture, or underlying protocols.

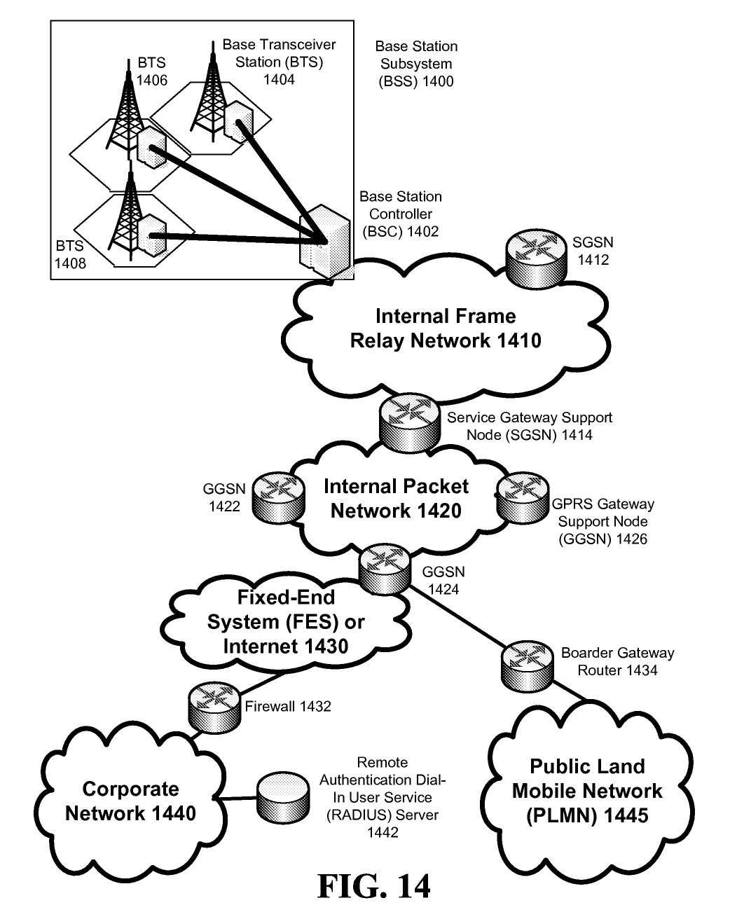

FIG. 14 depicts an overall block diagram of an exemplary packet-based mobile cellular network environment, such as a GPRS network, in which the disclosed subject matter may be practiced. In such an environment, there are a plurality of Base Station Subsystems (“BSS”) 1400 (only one is shown), each of which comprises a Base Station Controller (“BSC”) 1402 serving a plurality of Base Transceiver Stations (“BTS”) such as BTSs 1404, 1406, and 1408. BTSs 1404, 1406, 1408, etc. are the access points where users of packet-based mobile devices become connected to the wireless network. In exemplary fashion, the packet traffic originating from user devices is transported over the air interface to a BTS 1408, and from the BTS 1408 to the BSC 1402. Base station subsystems, such as BSS 1400, are a part of internal frame relay network 1410 that may include Service GPRS Support Nodes (“SGSN”) such as SGSN 1412 and 1414. Each SGSN is in turn connected to an internal packet network 1420 through which a SGSN 1412, 1414, etc. can route data packets to and from a plurality of gateway GPRS support nodes (GGSN) 1422, 1424, 1426, etc. As illustrated, SGSN 1414 and GGSNs 1422, 1424, and 1426 are part of internal packet network 1420. Gateway GPRS serving nodes 1422, 1424 and 1426 mainly provide an interface to external Internet Protocol (“IP”) networks such as Public Land Mobile Network (“PLMN”) 1445, corporate intranets 1440, or Fixed-End System (“FES”) or the public Internet 1430. As illustrated, subscriber corporate network 1440 may be connected to GGSN 1424 via firewall 1432; and PLMN 1445 is connected to GGSN 1424 via boarder gateway router 1434. The Remote Authentication Dial-In User Service (“RADIUS”) server 1442 may be used for caller authentication when a user of a mobile cellular device calls corporate network 1440.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the disclosed subject matter described herein may have aspects that are wholly in hardware, partly in hardware and partly in software, as well as in software. Furthermore, aspects may be fully integrated into a single component, be assembled from discrete devices, or implemented as a combination suitable to the particular application and is a matter of design choice. As used herein, the terms “node,” “access point,” “component,” “system,” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the systems of the disclosed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed subject matter. In the case of program code execution on programmable computers, the computing device generally includes a processor, a storage medium readable by the processor (including volatile and non-volatile memory and/or storage elements), at least one input device, and at least one output device.

Furthermore, the some aspects of the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

While for purposes of simplicity of explanation, methodologies disclosed herein are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the disclosed subject matter has been described in connection with the particular embodiments of the various figures, it is to be understood that other similar embodiments may be used or modifications and additions may be made to the described embodiment for performing the same function of the disclosed subject matter without deviating therefrom. Still further, the disclosed subject matter may be implemented in or across a plurality of processing chips or devices, and storage may similarly be effected across a plurality of devices. Therefore, the disclosed subject matter should not be limited to any single embodiment, but rather should be construed in breadth and scope in accordance with the appended claims.

What is claimed is:

1. A method for cross layer scheduling, the method comprising:
transmitting a first set of packets to selected users from a transmitter;
receiving acknowledgement and negative acknowledgement feedback from a set of the selected users;
updating system state of the transmitter based in part on receiving the feedback; and
determining a user selection, a power allocation, and a rate allocation for a subsequent set of packets based in part on a scheduling policy and the system state.

2. The method of claim 1, further comprising scheduling the first set of packets based in part on the scheduling policy and an estimated channel state information at the transmitter.

3. The method of claim 1, further comprising transmitting the subsequent set of packets based in part on the user selection, power allocation, and rate allocation.

4. The method of claim 1, further comprising determining the scheduling policy based in part on an optimal user selection policy, an optimal power allocation policy, and an optimal rate allocation policy.

5. The method of claim 4, further comprising deriving the optimal user selection policy, the optimal power allocation policy, and the optimal rate allocation policy recursively over a set of states of the transmitter.

6. The method of claim 5, the deriving includes optimizing an expression of an average total spectral efficiency for packets successfully delivered as a function of the estimated channel state information at the transmitter.

7. The method of claim 1, the scheduling policy includes a scheduling policy based in part on a quality of service constraint.

8. The method of claim 7, quality of service constraint includes a limit on conditional packet error probability of a set of users.

9. The method of claim 1, the transmitting includes transmitting on a time division duplexed downlink of a base station.

10. The method of claim 9, the transmitting includes transmitting from an orthogonal frequency division multiple access wireless node.

11. A communication apparatus comprising means for performing the method of claim 1.

12. A packet scheduling system, the system comprising:
a system state component configured to receive acknowledgement and negative acknowledgement feedback from a set of users in response to transmitting a first set of packets and to update the system state in response to receiving the feedback; and
an system output component configured to determine a system output comprising a user selection, a power allocation, and a rate allocation, the system output is based in part on the system state.

13. The system of claim 12, further comprising a radio transmitter associated with the system output component and configured to transmit packets according to a packet schedule based in part on the system output.

14. The system of claim 12, the system further comprising a computer component for estimating channel state information at the radio transmitter.

15. The system of claim 12, the system output component is further configured to receive and determine the system output based on a user selection policy, a power allocation policy, and a rate allocation policy.

16. The system of claim 14, the user selection policy, power allocation policy, rate allocation policy are recursively optimized over a set of states of the transmitter.

17. A device comprising:
a media access control layer component and a physical layer component;
wherein the media access control layer component is operable to receive acknowledgement and negative acknowledgement traffic in response to packets sent from the physical layer component;
wherein the media access control layer component is operable to update the device state in response to receiving the traffic;
wherein the media access control layer component is communicatively coupled to the physical layer component and operable to control power allocation, rate allocation, and user selection by the physical layer component according to a schedule; and
wherein the schedule is determined by the media access control layer component based in part on the device state and a scheduling policy.

18. The device of claim 17, the scheduling policy is based in part on an optimal user selection policy, an optimal power allocation policy, and an optimal rate allocation policy derived by recursive optimization over a set of states of the device.

19. The device of claim 17, wherein the physical layer component is operable send packets over a time division duplex downlink.

20. The device of claim 17, scheduling policy is based in part on a quality of service constraint including a limit on conditional packet error probability of a set of users.
